(19) United States
(12) Patent Application Publication
(10) Pub. No.: US 2021/0364299 A1
(43) Pub. Date: Nov. 25, 2021

(54) INFORMATION PROCESSING METHOD, INFORMATION PROCESSING APPARATUS, AND NON-TRANSITORY RECORDING MEDIUM

(71) Applicant: TOYOTA JIDOSHA KABUSHIKI KAISHA, Toyota-shi (JP)

(72) Inventors: Yoshiyasu TAKEZAWA, Okazaki-shi (JP); Hirotaka TODAKA, Toyota-shi (JP); Takao KIGUCHI, Nagoya-shi (JP); Chieko SAWADA, Nagoya-shi (JP); Yosuke TOKUDA, Toyota-shi (JP); Ayaka KAGAMI, Inazawa-shi (JP); Natsuki SUGIYAMA, Nisshin-shi (JP); Takuzo HIRANO, Nagoya-shi (JP); Taichi AMAKASU, Toyota-shi (JP); Seiei HIBINO, Nagakute-shi (JP); Hiroshi KAWAKAMI, Nisshin-shi (JP)

(73) Assignee: TOYOTA JIDOSHA KABUSHIKI KAISHA, Toyota-shi (JP)

(21) Appl. No.: 17/245,159

(22) Filed: Apr. 30, 2021

(30) Foreign Application Priority Data
May 21, 2020 (JP) 2020-088886

(51) Int. Cl. G01C 21/34; G06Q 10/08

(52) U.S. Cl. CPC G01C 21/343; H04W 4/024; G01C 21/3415; G06Q 10/08355

(57) ABSTRACT

The present disclosure efficiently performs delivery of delivery articles, collection of collection articles, and transportation of collection articles. The present disclosure is an information processing method including an information processing apparatus performing the following: setting a travel route of a vehicle that goes through both of a delivery position and a collection position based on information indicating the delivery position of a delivery article and information indicating the collection position of a collection article; and retrieving at least one recipient corresponding to an attribute of the collection article, and outputting information indicating the retrieved recipient.

### CROSS REFERENCE TO THE RELATED APPLICATION

This application claims the benefit of Japanese Patent Application No. 2020-088886, filed on May 21, 2020, which is hereby incorporated by reference herein in its entirety.

### BACKGROUND

### Technical Field

The present disclosure relates to an information processing method, an information processing apparatus, and a non-transitory recording medium.

### Description of the Related Art

Conventional techniques include the following. That is, on-vehicle equipment transmits to a control center a route request including the time of departure, point of departure, destination, load weight, and load type of a delivery car on which the on-vehicle equipment is mounted. The control center extracts a plurality of operation records that matches the time of departure, point of departure, destination, load weight, and load type in the received route request, from operation data, and transmits it to the on-vehicle equipment. The on-vehicle equipment displays the total fuel consumption, the arrival date and time, and the inside temperature range at the maximum lateral G for each received operation record, and sets a route included in an operation record selected by an occupant as a guide route (e.g., Japanese Patent Laid-Open No. 2014-149191).

[Patent document 1] Japanese Patent Laid-Open No. 2014-149191

### SUMMARY

One or more aspects of the present disclosure are directed to provide an information processing method, an information processing apparatus, and a non-transitory recording medium including a program recorded therein that make it possible to efficiently perform delivery of delivery articles, collection of collection articles, and transportation of collection articles.

An aspect of the present disclosure may be an information processing method comprising the following: setting a travel route of a vehicle that goes through both of a delivery position and a collection position based on information indicating the delivery position of a delivery article and information indicating the collection position of a collection article; and retrieving at least one recipient corresponding to an attribute of the collection article, and outputting information indicating the retrieved recipient.

Aspects of the present disclosure may include at least one of an information processing apparatus, and a recording medium including a program recorded therein that include the same features as the information processing method. Further, aspects of the present disclosure may include an information processing system including an information processing apparatus and a terminal connected to the information processing apparatus via a network, and may include each of a server and the terminal in the information processing system.

According to the present disclosure, it is possible to efficiently perform delivery, collection, and transportation of collection articles.

### BRIEF DESCRIPTION OF THE DRAWINGS

FIG. 1 is a schematic diagram of an information processing system according to an embodiment;

FIG. 2 illustrates an example configuration of a server;

FIG. 3 is an example configuration of a terminal apparatus that is usable as each of the terminals illustrated in FIG. 1;

FIG. 4 is a sequence diagram illustrating an example operation of the information processing system;

FIG. 5A illustrates an example format of a message of a delivery request, and illustrates delivery information included in the delivery request;

FIG. 5B illustrates an example format of a message of a collection request, and illustrates collection information included in the collection request;

FIG. 6A illustrates an example data configuration of a delivery table;

FIG. 6B illustrates an example data configuration of a collection table;

FIG. 7 is a flowchart illustrating an example process of generating a delivery and collection instruction;

FIG. 8A illustrates an example data configuration of a correspondence table, and FIG. 8B illustrates an example data configuration of a recipient table;

FIG. 9 illustrates an example format of a message of a delivery and collection instruction;

FIG. 10 is a flowchart of an example process of setting a travel route of a vehicle in a terminal;

FIG. 11A is an explanatory diagram of a first mode, FIG. 11B is an explanatory diagram of a second mode, and FIG. 11C is an explanatory diagram of a third mode; and

FIG. 12 is a flowchart illustrating an example process of setting a route of a recipient that is performed in the terminal.

### DESCRIPTION OF THE EMBODIMENTS

When a person that conducts delivery business such as a delivery company delivers delivery articles using a vehicle, it is a waste of loading space and time to travel with the loading space of the vehicle remaining empty after delivery. For this reason, it is preferable to effectively utilize the loading space by carrying out delivering of delivery articles in combination with collection of collection articles.

In collecting collection articles, recipients of the collection articles where the collection articles are unloaded may be different depending on the attributes of the collection articles, and their locations may also be different. In such a case, a driver may be unsure about which collection article is to be transported to which recipient, and where is the recipient. Further, the driver may be unfamiliar with the area where he/she drives the vehicle. In these cases, the driver may feel burdened in determining a recipient and grasping a transportation route. In an embodiment, when collection of collection articles is carried out in addition to delivering of delivery articles, assistance related to recipients of the collection articles is provided to reduce the burden on the driver, thereby making it possible to efficiently perform delivery, collection, and transportation of collection articles to recipients.

Further, when it is assumed to always separately travel along a delivery route, a collection route, and a transportation route of collection articles, the travel distance may extend meaninglessly to be a burden on the driver, as well as causing waste of time and energy. In an embodiment, when collection of collection articles is carried out in addition to delivering of delivery articles, searching for a route for delivery, collection, and transportation of collection articles to recipients is assisted to reduce a burden on a driver, thereby making it possible to efficiently perform delivery, collection, and transportation of collection articles to recipients.

An information processing method according to an embodiment including:
(1) setting a travel route of a vehicle that goes through both of a delivery position and a collection position based on information indicating the delivery position of a delivery article and information indicating the collection position of a collection article; and
(2) retrieving at least one recipient corresponding to an attribute of the collection article, and outputting information indicating the retrieved recipient.

According to the information processing method, delivery and collection are performed, thereby making it possible to avoid a state where the loading space of the vehicle is wastefully empty. Further, by outputting a recipient corresponding to an attribute of a collection article, the collection article can be transported to a proper recipient without confusion, so that a waste of time can be saved. In this way, according to the information processing method, it is possible to efficiently perform delivery, collection, and transportation of collection articles.

Here, the kind of a delivery article is not limited as long as it can be delivered by a vehicle. Delivery articles include baggage, rental (lent) goods, sales (transferred) articles, and articles (e.g., laundry, or equipment to be repaired) temporarily stored for service provision (e.g., cleaning, repair, or maintenance). Delivery articles include, for example, clothing, bedding, food, sundries, sporting goods, books, appliances, furniture, machines, instruments, and tools. Further, delivery articles also include a container box that is placed at a predetermined position, and is for containing collection articles. A collection article is an article that is temporarily stored in order to receive service, or a waste article. Waste articles may be classified into, for example, recyclable waste (cans and bottles, or paper waste), combustible waste, non-combustible waste, and food waste. Delivery articles and collection articles transported by a vehicle may be of the same kind or of different kinds.

Delivery positions and collection positions are general households or the sites of organizations such as companies, parking lots, or vacant lots, and are not limited particularly as long as a vehicle can be temporarily stopped or parked to unload delivery articles or load collection articles. One or two or more delivery positions and one or two or more collection positions are provided in response to a request for delivery and collection.

In setting a travel route of a vehicle, each of delivery positions and collection positions is treated as a via-point. The first via-point may be a delivery position or a collection position. Further, when there is a plurality of delivery positions, it is possible to finish delivery to the plurality of delivery position and then travel to collection positions, or to alternately or randomly go through the delivery positions and the collection positions. It is possible to travel to a recipient after all of the deliveries and collections have been finished, or between the deliveries and collections.

As long as delivery articles and collection articles can be transported, a vehicle is selected from, for example, transportation vehicles including trucks and trailers, passenger cars, motorcycles, motorized bicycles, and light vehicles. A vehicle may be a general-purpose vehicle or a special-purpose vehicle. It is possible to employ a vehicle as a special-purpose vehicle that can be separated into an upper part for containing delivery articles and collection articles and a lower part provided with a self-propelled mechanism, place the upper part separated from the lower part at a collection position so that collection articles can be contained in the upper part, and collect the upper part inclusive of the collection articles. Further, it is possible to load a container box for collection articles on a vehicle and place it at a collection position. A loading space for delivery articles and a loading space for collection articles on a vehicle may be shared or separate.

A recipient of collection articles is a facility for keeping collection articles or performing some kind of process on collection articles. For example, when a collection article is laundry, facilities that handle washing of large-sized items (e.g., futons and blankets), facilities that perform dry cleaning, and facilities that perform normal washing may be separately provided. Alternatively, when a collection article is waste, transportation destinations of cans and bottles, paper waste, combustible waste, and non-combustible waste may be different from one another. Such a difference between recipients is caused due to the attribute of a collection article. Although the attribute of a collection article is, for example, the kind of the collection article and the way to process the collection article, they are not limited thereto.

Information indicating a recipient is preferably configured to include information indicating the position of the recipient and information indicating a route to the position of the recipient. Presenting or informing the position and the route makes it easy for the driver of the vehicle to grasp the recipient. Accordingly, a time for the driver to find out a recipient or to find out a way thereto can be eliminated, so that time can be used without waste.

Further, a configuration may be employed in which information for prompting a change of the next via-point in the travel route to the position of the recipient is output together with information indicating the recipient. For example, when a collection article is loaded at a collection position, the recipient may be closer than the delivery position or the collection position corresponding to the next via-point. In this case, by changing the next via-point to the recipient, the travel route length can be shortened to avoid the occurrence of a waste of time.

For this reason, it is preferable to output information indicating the recipient when the relationship between the position of the vehicle and the position of the recipient becomes a predetermined relationship. The predetermined relationship is, for example, that the distance between the position of the vehicle and the position of the recipient becomes shorter than a threshold. Alternatively, the predetermined relationship is that the position of the vehicle enters a predetermined geographical area including the recipient. The geographical area may be a circular area with a predetermined radius centered at the position of the recipient, may be an administrative division (e.g., municipalities) including the position of the recipient, or may be an area that is obtained by dividing the ground into squares, hexagons, or octagons and that includes the position of the recipient.

Further, a configuration may be employed in which, when a plurality of recipients that can receive the collection article is retrieved, one recipient is selected from among the plurality of recipients based on an attribute of a collection article that can be received by the selected recipient. In retrieving a recipient, two or more recipients may be retrieved. In this case, one recipient may be selected by giving priority to the distance from the position of the vehicle. Alternatively, as mentioned above, a configuration may be employed in which one recipient is selected based on the attributes of collection articles that can be received by each recipient. That is, a recipient may be selected that can receive two or more kinds of collection articles including different attributes that are loaded on the vehicle. This is because a waste of time is more reduced when two or more kinds of collection articles can be unloaded at one place than when visiting a plurality of recipients to unload collection articles.

Further, the information processing method may employ the following configuration. That is, the travel route may be set in one of: a first mode in which the travel route is set so as to go through the delivery position, then go through the collection position, and thereafter go through the position of the recipient; a second mode in which the travel route is set so as to go through the delivery position and the collection position in a passing order in which the delivery position and the collection position are mixed, and thereafter go through the position of the recipient; and a third mode in which the travel route is set in a passing order in which the delivery position, the collection position, and the position of the recipient are mixed.

### Embodiment

Hereinafter, an information processing method, an information processing apparatus, and a recording medium including a program recorded therein according to an embodiment will be described with reference to the drawings. The configuration of the embodiment is an example, and there is no limitation to the configuration of the embodiment.

<System Configuration>

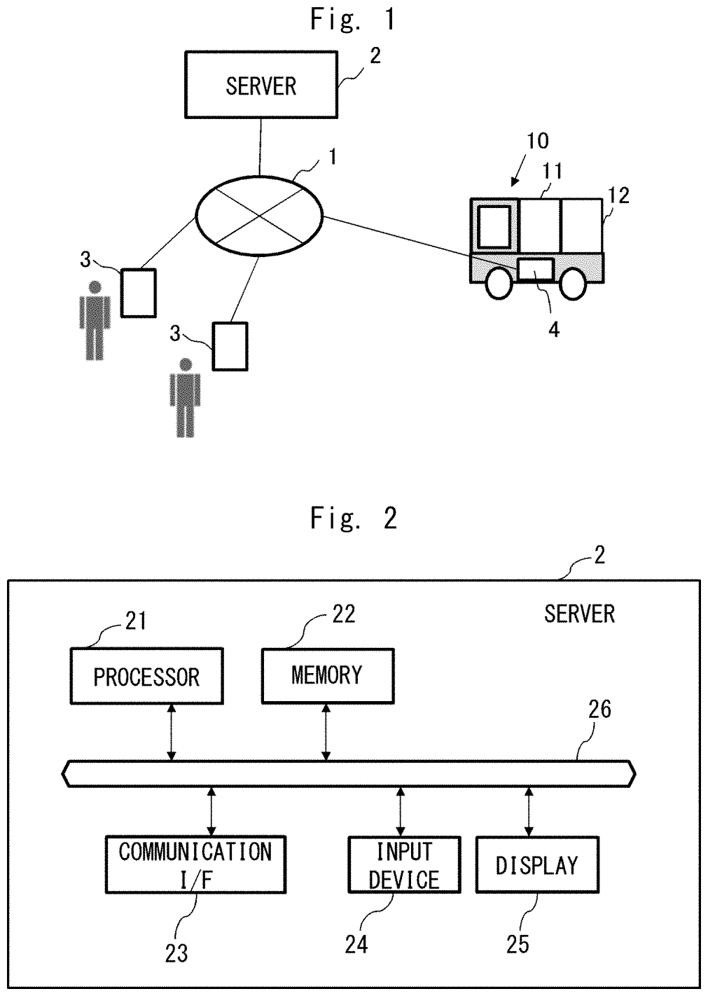

FIG. 1 is a schematic diagram of an information processing system according to an embodiment. The information processing system manages delivery of delivery articles and collection of collection articles. Further, the information processing system supplies information for controlling or assisting travel of a vehicle 10 that performs delivery and collection.

In FIG. 1, the information processing system includes a network 1, a server 2 connected to the network 1, and a terminal 3 and a terminal 4 that can communication with the server 2. The network 1 is, for example, a public communication network such as the Internet. As a public wireless network, for example, WAN (wide area network) and other communication networks are exemplified. The network 1 may include a wireless network. The wireless network is, for example, a cellular network such as LTE (long team evolution) or a wireless LAN (local area network: including Wi-Fi (registered trademark)).

The terminal 3 is a terminal carried by a requester of at least either delivery of a delivery article or collection of a collection article. A requester of each of delivery and collection may be an individual or a company (corporation). The terminal 3 transmits information indicating a request for delivery and collection to the server 2. The terminal 4 is a terminal mounted on the vehicle 10 used for delivery and collection.

The terminal 4 is an example of “information processing apparatus”. The terminal 4 communicates with the server 2 to receive, from the server 2, an instruction to deliver delivery articles and collect collection articles (a delivery and collection instruction) including information indicating delivery positions and collection positions in a predetermined period of time (e.g., date or morning/afternoon). The vehicle 10 travels according to a travel route that goes through the delivery positions and the collection positions to perform delivery and collection.

The vehicle 10 includes a container box 11 for containing delivery articles and a container box 12 for containing collection articles. The container box 12 can be separated from the vehicle 10, and can be placed at collection positions. The container box 12 contains a collection article that a user wants to be collected. The container box 12 can be used for the purpose of collecting collection articles inclusive of the container box 12 after a certain amount of time has elapsed.

Upon receiving a delivery request of a delivery article and a collection request of a collection article, the server 2 performs a process of setting a travel route of the vehicle 10 that goes through a delivery position and a collection position. Further, the server 2 performs a process of transmitting (outputting or supplying) to the terminal 4 a delivery and collection instruction including information indicating the delivery position and the collection position and information indicating the travel route. Collection positions include a position determined in advance as a place for placing collection articles, and a position specified by a request for collection. The attribute (e.g., kind) of a collection article may be indicated in a request for collection, or may be known for the first time by recognizing the collection article placed at a collection position.

<Configuration of Server>

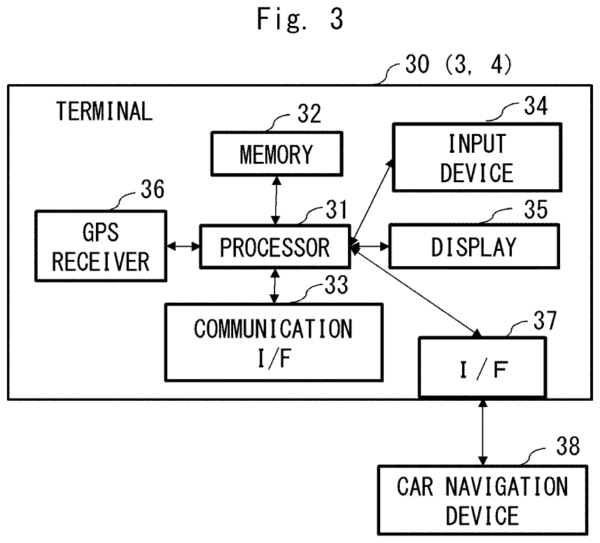

FIG. 2 illustrates an example configuration of the server 2. For example, the server 2 is operated by a business operator that performs delivery and collection using the vehicle 10. However, the operator is not limited. The server 2 can be configured using a general-purpose information processing apparatus (computer) such as a personal computer (PC) or a workstation (WS), or a special-purpose information processing apparatus such as a server machine. The server 2 includes a communication function, and can be connected to the network 1 via wired communication or wireless communication.

The server 2 includes a processor 21 as a processing unit or a controller, a memory 22, a communication interface (communication IF) 23, an input device 24, and a display 25 that are connected to each other via a bus 26. The server 2 may be one information processing apparatus or a set (cloud) of two or more information processing apparatuses.

The memory 22 includes a main memory and an auxiliary memory. The main memory is used as, for example, a memory area for programs and data, a development area for programs, a working area for programs, and a buffer area for communication data. The main memory is configured using a RAM (random access memory), or a combination of a RAM and a ROM (read only memory). The auxiliary memory is used as a memory area for data and programs. The auxiliary memory includes a non-volatile storage medium such as a hard disk, a solid state drive (SSD), a flash memory, and an EEPROM (electrically erasable programmable read-only memory).

The communication IF 23 is a circuit that performs a communication process. For example, the communication IF 23 is a network interface card (NIC). Further, the communication IF 23 may be a circuit that performs wireless communication (e.g., LTE, 5G, or wireless LAN (Wi-Fi (registered trademark))), or may be a NIC and a wireless communication circuit.

The input device 24 includes at least one of, for example, keys, buttons, a pointing device, and a touch panel, and is used for inputting information. The display 25 is, for example, a liquid crystal display, and displays information and data.

The processor 21 is, for example, a CPU (central processing unit). The processor 21 performs various processes by executing various kinds of programs stored in the memory 22.

For example, the processor 21 performs a process of determining delivery positions of delivery articles and collection positions of collection articles in a predetermined period of time. Further, the processor 21 performs a process of setting a travel route of the vehicle that goes through the delivery positions and the collection positions. Further, the processor 21 performs a process of transmitting to the terminal 4 a delivery and collection instruction including information indicating the delivery positions and the collection positions and information indicating the travel route.

<Configuration of Terminal>

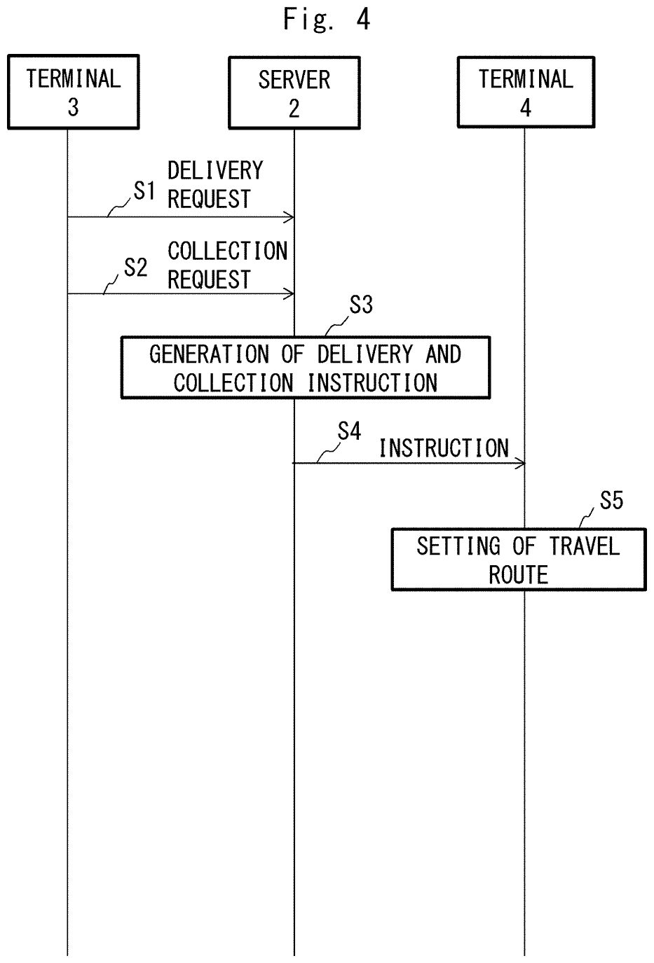

FIG. 3 illustrates an example configuration of a terminal apparatus 30 that is usable as each of the terminal 3 and the terminal 4 illustrated in FIG. 1. The terminal 3 may be a mobile terminal (wireless terminal) or a stationary terminal. The terminal 4 may be a mobile terminal carried by the driver when the driver gets in the vehicle 10, or may be an on-vehicle terminal installed in the vehicle 10. When each of the terminals 3 and 4 is a mobile terminal, the terminal apparatus 30 may be a portable terminal (a communication terminal with portability) such as a laptop PC, a smart device (including a smartphone, a tablet terminal, etc.), a personal digital assistant (PDA), and a wearable computer. When the terminal 3 is a stationary terminal, each of the terminals 3 and 4 may be a PC or a WS. The terminal apparatus 30 may be a general-purpose information processing apparatus or a special-purpose information processing apparatus.

The terminal apparatus 30 includes a processor 31, a memory 32, a communication interface (communication IF) 33, an input device 34, and a display 35. As each of the processor 31, the memory 32, the communication IF 33, the input device 34, and the display 35, the same as described with respect to the processor 21, the memory 22, the communication IF 23, the input device 24, and the display 25 can be applied. However, those different in performance from those applied to the server 2 are applied depending on a difference between uses, purposes of use, and the like.

Further, the terminal apparatus 30 includes a GPS receiver 36 that detects the position of the terminal apparatus 30, and an interface circuit (I/F) 37. The terminal apparatus 30 as the terminal 4 is connected to a car navigation device 38 mounted on the vehicle 10 via the I/F 37. The processor 31 executes various types of programs stored in the memory 32 to cause the terminal apparatus 30 to operate as each of the terminals 3 and 4.

Note that as each of the processor 21 and the processor 31, a plurality of CPUs or a multi-core type CPU may be applied. At least part of processes performed by a CPU may be performed by a processor other than a CPU such as a DSP (digital signal processor) or a GPU (graphical processing unit). Further, at least part of processes performed by a CPU may be executed by a special-purpose or general-purpose integrated circuit such as an ASIC (application specific integrated circuit) and an FPGA (field programmable gate array), or a combination of a processor and an integrated circuit. The combination is called as, for example, a microcontroller (MCU), an SoC (system-on-a-chip), a system LSI, and a chipset. Further, a part of processes performed in the processor 21 may be performed in the processor 31.

<Example Operation>

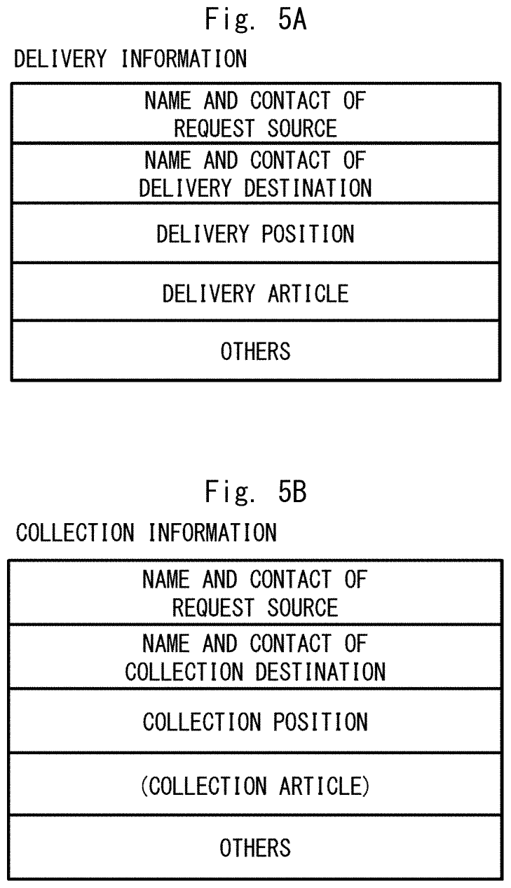

Hereinafter, an example operation of the information processing system will be described. FIG. 4 is a sequence diagram illustrating an example operation of the information processing system. In FIG. 4, a requester who desires delivery transmits a message of a delivery request to the server 2 using the terminal 3 (step S1). Further, a requester who desires collection transmits a message of a collection request to the server 2 using the terminal 3 (step S2).

However, the server 2 may be configured to acquire a delivery request and a collection request from other than the terminal 3. That is, a delivery request and a collection request may be acquired from communication equipment other than the terminal 3 via the network 1. Alternatively, a delivery request and a collection request that are directly input to the server 2 may be acquired, or a delivery request and a collection request that are read from a removable memory such as a USB memory may be acquired.

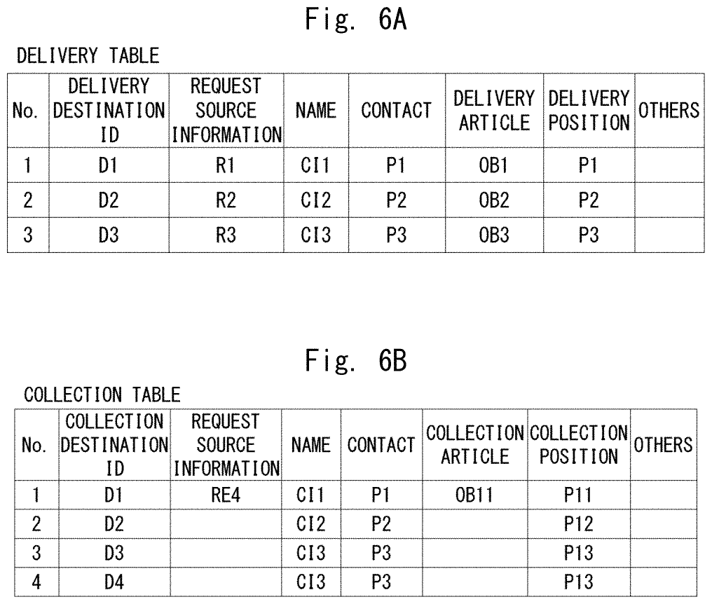

FIG. 5A illustrates an example format of a message of a delivery request, and illustrates delivery information included in the delivery request. The delivery information includes information indicating the name and contact (e.g., a phone number and an email address) of a request source of delivery, information indicating the name and contact of a delivery destination, information indicating a delivery position (delivery location), information indicating a delivery article, and other information.

FIG. 5B illustrates an example format of a message of a collection request, and illustrates collection information included in the collection request. The collection information includes information indicating the name and contact of a request source of collection, information indicating the name and contact of a collection destination, information indicating a collection position (collection location), information indicating a collection article, and other information. As for collection, a request source may instruct collection of a collection article, and not specify a collection article. In this case, information indicating a collection article is not included in the collection information.

In the server 2, the processor 21 receives a delivery request and a collection request via the communication IF 23. The processor 21 registers the information included in the delivery request in a delivery table, and registers the information included in collection request in a collection table. Although each of the delivery table and the collection table is stored in the memory 22, they may be stored in something other than the memory 22 as long as the processor 21 can access it.

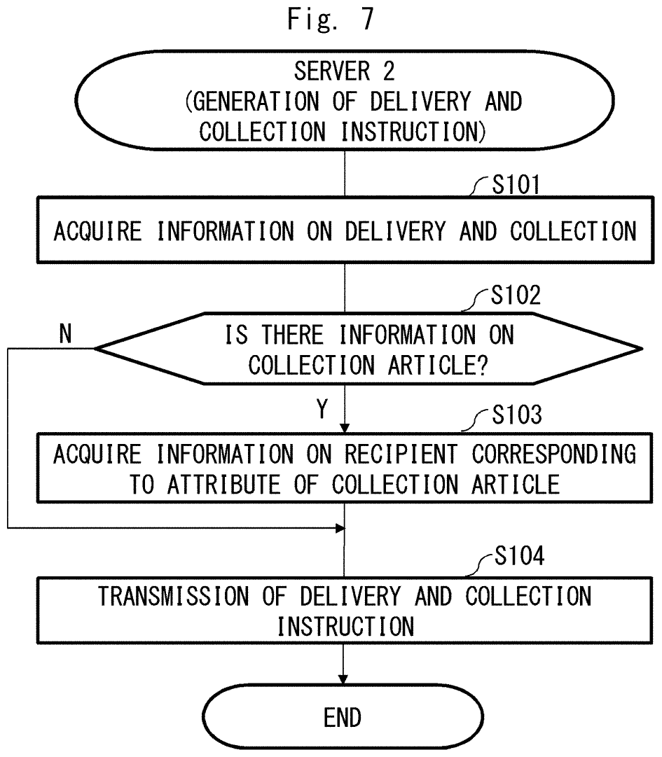

FIG. 6A illustrates an example data configuration of the delivery table. The delivery table consists of one or more records (entries) indicating each delivery assigned to a certain vehicle 10 for a certain period of time. An entry includes, as information elements, delivery destination ID (an identifier of a delivery destination), request source information (the name and contact of a delivery request source), the name of the delivery destination, a contact of the delivery destination, information indicating a delivery article, information indicating a delivery position, and other information.

FIG. 6B illustrates an example data configuration of the collection table. The collection table consists of one or more records (entries) indicating each collection assigned to a certain vehicle 10 for a certain period of time. An entry includes, as information elements, collection destination ID (an identifier of a collection destination), request source information (the name and contact of a collection request source), the name of the collection destination, a contact of the collection destination, information indicating a collection article, information indicating a collection position, and other information.

Collection may be an event triggered by a collection request, or may be an event that is periodically (regularly) performed irrespective of the presence or absence of a request. An entry for a periodically performed collection event is permanently registered in the collection table until the end of the collection event. For this reason, an entry based on a collection request is additionally registered in the collection table. For example, the entries with entry numbers of 2, 3, and 4 illustrated in FIG. 6B are entries of periodic collection events, and do not include request source information and information on a collection article. What the collection article is unknown until going to the collection position and see the collection article placed there. However, in periodic collection, when a predetermined collection article is collected, information indicating the collection article is included.

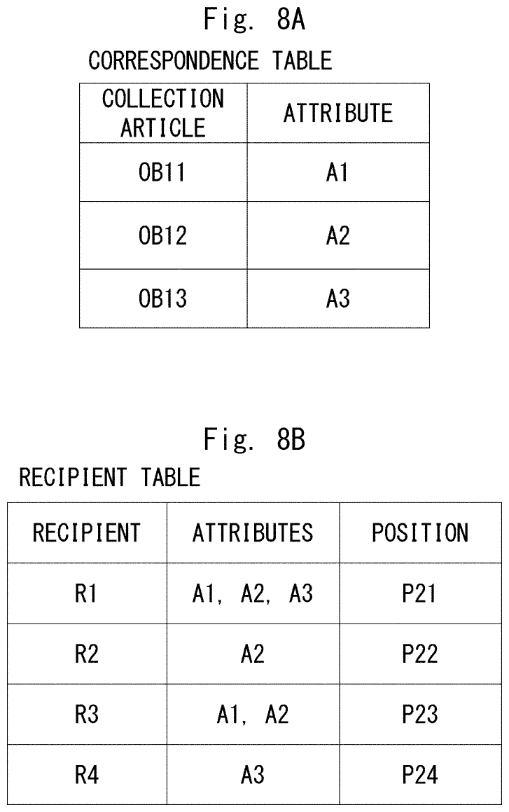

The processor of the server 2 performs a process of generating a delivery and collection instruction at a predetermined date and time (e.g., a predetermined time on the day before the delivery and collection on the next day). FIG. 7 is a flowchart illustrating an example process of generating a delivery and collection instruction.

In step S101, the processor 21 of the server 2 acquires information on delivery and collection from the delivery table and collection table. In step S102, it is determined whether information indicating a collection article is included in the information on delivery and collection. When it is determined that information indicating a collection article is included, the processing proceeds to step S103, and otherwise the processing proceeds to step S104.

In step S103, the processor 21 acquires information on a recipient corresponding to the attribute of the collection article. In acquiring information on a recipient, a correspondence table between collection articles and their attributes and information stored in the recipient table are used.

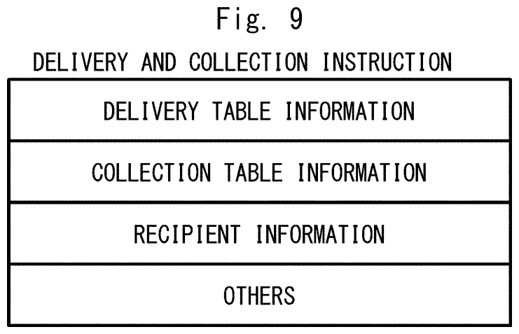

FIG. 8A illustrates an example data configuration of the correspondence table, and FIG. 8B illustrates an example data configuration of the recipient table. The correspondence table and the recipient table are stored in the memory 22 or a memory area other than the memory 22 that can be accessed by the processor 21.

An entry for each collection article is stored in the correspondence table. An entry stores a correspondence relationship (association) between information indicating a collection article and information indicating an attribute of the collection article. The recipient table consists of an entry for each recipient. An entry stores association between information indicating a recipient and information indicating the attributes of collection articles that can be received by the recipient and the position of the recipient.

In step S103, the processor 21 acquires information indicating the attribute corresponding to the collection article from the correspondence table, and acquires an entry corresponding to the information indicating the attribute, that is, an entry indicating the recipient that can receive the collection article from the recipient table. Then, the processing proceeds to step S104.

In step S104, the processor 21 generates and outputs a message of a delivery and collection instruction, and transmits it to the terminal 4 via the communication IF 23 (step S4 in FIG. 4). The network address of the terminal 4 is known in the server 2.

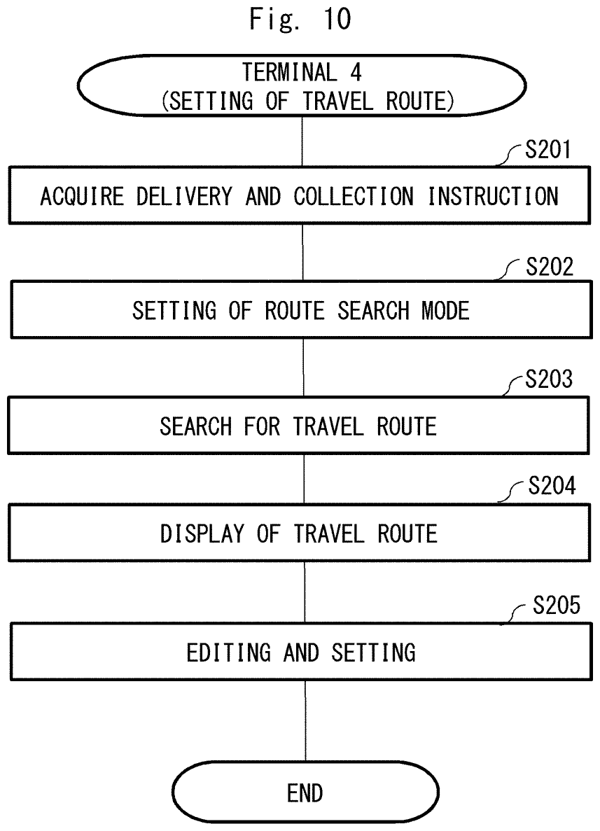

FIG. 9 illustrates an example format of a message of a delivery and collection instruction. The delivery and collection instruction includes delivery table information, collection table information, recipient information, and other information. The delivery table information is information indicating the registered content in the delivery table (FIG. 6A). The collection table information is information indicating the registered content in the collection table (FIG. 6B). The recipient information is information in the entries of the recipient table acquired in step S103.

In FIG. 4, in the terminal 4, the processor 31 of the terminal 4 performs a process of setting a travel route (step S5). An application program (app) that pertains, for example, a process of setting a travel route of the vehicle 10 is installed in the terminal 4. By executing the app, the processor 31 performs a process as follows.

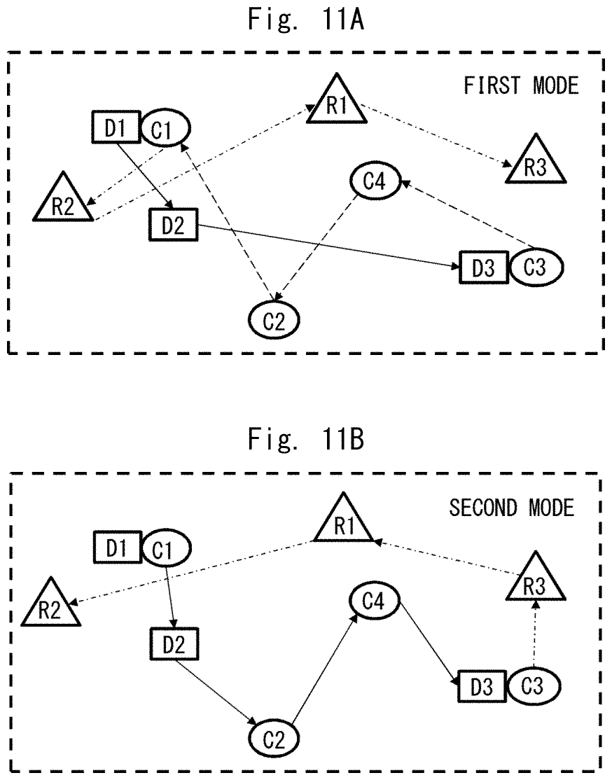

FIG. 10 is a flowchart illustrating an example process of setting a travel route of the vehicle 10 in the terminal 4. In step S201, the processor 31 acquires a delivery and collection instruction (FIG. 9).

In step S202, the processor 31 sets a route search mode. Here, a travel route of the vehicle 10 can be searched for using one of the first, second, and third modes.

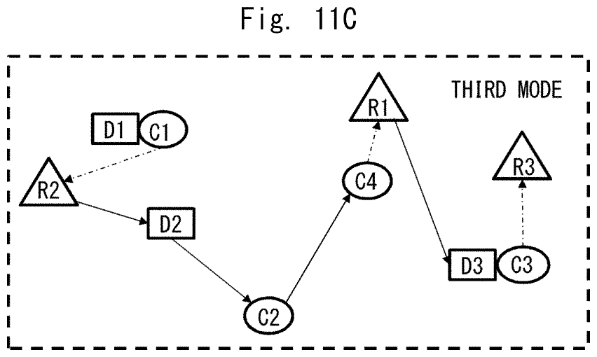

FIG. 11A is an explanatory diagram of the first mode, FIG. 11B is an explanatory diagram of the second mode, and FIG. 11C is an explanatory diagram of the third mode. In each of FIGS. 11A, 11B and 11C, each of D1, D2 and D3 indicates a delivery destination (delivery position). C1, C2, C3 and C4 indicate collection destinations (collection positions). Each of R1, R2 and R3 indicates the position of the recipient of the collection article.

The position of a base in which the vehicle 10 is kept is set as the point of departure and the final destination in a travel route of the vehicle 10. Then, each of the delivery positions, the collection positions, and the positions of the recipients is set as a via-point in a travel route of the vehicle 10. However, the mode is different depending on a difference in priority for each action of delivery, collection, and transportation of collection articles to a recipient.

In the first mode, a travel route of the vehicle 10 is set that goes through the via-points in the order of the delivery positions to the collection positions to the positions of the recipients of collection articles. In the example illustrated in FIG. 11A, D1 closest to the base is set as the first via-point, and the delivery position closest thereto is set as the next via-point. Thereby, it is determined to go through the delivery positions in the order of D1→D2→D3. Further, C3 that is the closest collection position from D3 that is the last delivery position is set as the next via-point. Thereby, it is determined to go through the collection positions in the order of C3→C4→C2→C1. Then, when R2 that is the closest recipient from Cl that is the last collection position can receive collection articles, R2 is set as the next via-point. Further, when all the collection articles cannot be received in R2, settings to go through R1 and R3 are made.

In the second mode, the priorities of delivery and collection are the same. For this reason, a travel route is set in a passing order in which the delivery positions and the collection positions are mixed. In the example illustrated in FIG. 11B, the closest delivery position or collection position is set as the next via-point, so that a travel route that, in the order of D1→C1→D2→C2→C4→D3→C3, goes through them is set. Similarly, in the second mode, transportation of collection articles to a recipient is performed after delivery and collection. R3 that is the closest recipient from C3 that is the final via-point of delivery and collection is set as the next via-point, and then via-points are set in the order of R1 and R2.

In the third mode, the priorities of delivery, collection, and transportation to recipients are almost the same, and a travel route is set in a passing order in which the delivery positions, the collection positions, and the positions of the recipients are mixed. In the third mode, in the case of having gone through a collection position, when a predetermined condition is satisfied, for example, when a recipient that can receive the collection article is within a predetermined distance range from the collection position, or when the recipient is closer than other delivery positions and collection positions, the recipient is set as the next via-point. In the example illustrated in FIG. 11C, the next via-point of the collection position C1 is set to a recipient R2 that receives the collection articles collected at the collection position C1, and thereafter a travel to the next delivery position D2 is set. Further, the next via-point of the collection position C4 is set to a recipient R1 that corresponds to the closest. Which of the first, second, and third modes should be selected is on a case-by-case basis, and the right of choice may be delegated to the driver of the vehicle 10. Of course, any mode may be set forcibly.

In step S202, the processor 31 can display information indicating that one of the first, second, and third modes should be selected on the display 35, and the operator of the terminal 4 (e.g., the driver of the vehicle 10) can input a selection result of a mode using the input device 34. Then, the processor 31 searches for a travel route (a passing order) according to one of the first, second, and third modes whose input has been received (step S203), and displays a travel route of a search result on the display 35 (step S204). Further, the operator can call and refer to individual information such as the name and contact of each of delivery destinations, collection destinations, and recipients on the display 35 as information on each via-point at appropriate timing.

The operator of the terminal 4 refers to a travel route (a passing order) displayed on the display 35, and when including a desire to rearrange the order, can perform editing work for changing the passing order using the input device 34. Then, when an input for fixing the final passing order is input from the input device 34, setting of a travel route is fixed (step S205). The processor 31 sends information on the set travel route to the car navigation device 38. Thereby, the driver of the vehicle 10 can set the travel route in the car navigation device 38, and drive the vehicle 10 according to guide information displayed on the display provided in the car navigation device 38. Further, the terminal 4 may operate as the car navigation device so that information for guiding the travel route of the vehicle 10 is displayed on the display 35. At this time, the position of the terminal 4 obtained by the GPS receiver 36 may be displayed on the display 35 as the position of the vehicle 10. Note that the loading position of delivery articles may be set as the first via-point, or the delivery articles may be loaded at the base. Further, it is possible to install a container box 12 at each collection position as one of the delivery articles, and at a later date, collect the container box 12 containing collection articles as a collection article.

Note that although the terminal 4 searches for a travel route in this embodiment, it is possible that a travel route is searched for on the server 2, and information indicating a travel route (a passing order) is included in a delivery and collection instruction and received by the terminal 4, and the terminal 4 sets the information on the travel route in the car navigation device 38 or the app.

In the above description of the first, second and third modes, it is assumed that the attribute of the collection article and the recipient of the collection article are known at the time of searching for a travel route. However, when the presence or absence of a collection article and the attribute of the collection article are not known unless going to the collection position, a process as follows is performed.

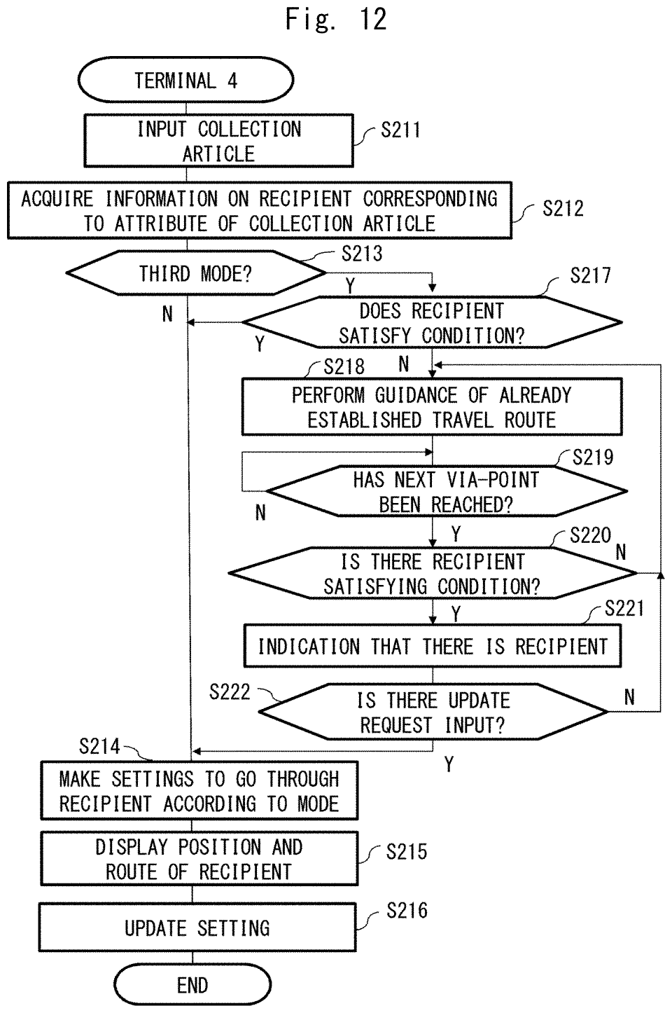

FIG. 12 is a flowchart illustrating an example process of setting a route of a recipient that is performed in the terminal 4. The driver who has loaded a collection article on the vehicle 10 at a collection position inputs information indicating the collection article to the terminal 4 using the input device 34 (step S211). The input may be in the form of allowing input of the name or identifier of the collection article, or may be in the form of causing the processor 31 to display a list of collection articles on the display 35, and allowing the operator to check a corresponding collection article.

In step S212, the processor 31 that has received the information indicating the collection article acquires information on a recipient corresponding to the attribute of the collection article. In the process of step S212, the processor 31 generates a message for inquiring a recipient corresponding to the attribute. The inquiring message is transmitted to the server 2. In the server 2, the processor 21 acquires information on the recipient corresponding to the attribute using the correspondence table and the recipient table, and transmits it to the terminal 4 as a response to the inquiry. In this way, the processor 31 acquires information on the recipient of the collection article. Note that a configuration may be employed in which the content of the correspondence table and the recipient table is included in the delivery and collection instruction. In this case, the processor 31 does not make an inquiry, and acquires information on the recipient of the collection article using the correspondence table and the recipient table.

In step S213, the processor 31 determines whether the current mode is the third mode or not. When the mode is determined to be the third mode, the processing proceeds to step S217, and otherwise (when the mode is determined to be the first or second mode), the processing proceeds to step S214.

In step S214, the processor 31 sets a travel route that goes through the recipient according to the current mode. In the first and second modes, a travel route that goes through the recipient acquired in step S212 is searched for after delivery and collection. In the third mode, the recipient is set as the next via-point. However, when the recipient acquired in step S212 has already been included as one of the via-points, there may be no change in the travel route or the passing order.

In step S215, the processor 31 displays (outputs) the position and route of the recipient acquired in step S212 on the display 35 to inform the driver of the recipient of the collection articles and its route. However, display of the route may be optional. In step S216, when there is a change in the travel route, the processor 31 performs update setting of the travel route.

In step S217, the processor 31 determines whether the recipient acquired in step S212 satisfies a condition set for the next via-point. This determination can be performed based on whether the relationship between the position of the vehicle 10 and the position of the recipient has become a predetermined relationship. The predetermined relationship may be that the distance between the position of the vehicle 10 and the position of the recipient has become shorter than a threshold, or may be that the position of the vehicle 10 has entered a predetermined geographical area including the recipient.

In step S217, when it is determined that the condition has been satisfied, the processing proceeds to 5214, and a via-point is set according to the third mode. When it is determined that the condition has not been satisfied, the processing proceeds to step S218.

Meanwhile, in step S212, a plurality of recipients that can receive the collection articles may be retrieved, and any of them may be determined to satisfy the condition in step S217. In this case, the closest recipient from the current position of the vehicle 10 of the plurality of retrieved recipients may be set as the next via-point. Alternatively, one recipient may be selected based on the attribute of the collection article loaded on the vehicle 10. For example, as one recipient, a recipient that is not the closest may be set as the next via-point.

For example, this will be described by taking the registered content in the recipient table illustrated in FIG. 8B as an example. It is assumed that the attribute of the collection article that is input in step S212 is A2, and R1 and R2 are acquired as recipients that satisfy the condition that the distance from the vehicle 10 is shorter than the threshold. Further, it is assumed that the distance between the vehicle 10 and R2 is shorter than the distance between the vehicle 10 and R1. Furthermore, a collection article including the attribute Al and a collection article including the attribute A2 are now loaded on the vehicle 10. Under these assumptions, the processor 31 sets, as the next via-point, a recipient that includes more attributes (kinds) that can receive the collection articles loaded on the vehicle 10 from among two or more recipients satisfying the condition. Under the above assumptions, the processor 31 sets R1 that can receive both the attributes A1 and A2 as the next via-point rather than R2 that can receive the attribute A2. This is because it is more efficient to unload the collection articles including A1 and A2 at R1 than going through R2 and then going to R1. The processor 31 can perform such a process in setting a via-point according to the third mode in step S214.

When the processing proceeds to step S218, the processor 31 pertains guidance of an already established travel route. In step S219, the processor 31 determines whether the next via-point has been reached. At this time, when it is determined that the next via-point has been reached, the processor 31 determines whether a condition for the recipient to be set as the next via-point has been satisfied at that via-point (step S220). When it is determined that there is a recipient satisfying the condition, the processing proceeds to step S221, and otherwise the processing returns to step S218.

In step S221, the processor 31 performs a process of displaying an indication (pop-up) that there is a recipient on the display 35. This indication includes an instruction to input a selection result of whether to request a change of the next via-point. This instruction is an example of “information for prompting a change of the next via-point in the travel route to the position of the recipient”. Here, when the processor 31 determines that an input for requesting a change of the next via-point (an update request input) has been input using the input device 34 (Y in step S222), the processing proceeds to step S214, and a process of changing the next via-point to the recipient is performed. On the contrary, when it is determined that there is no update request input, the processing proceeds to step S218.

According to the embodiment, the vehicle 10 can travel along a travel route that efficiently go through the delivery positions, the collection positions, and the positions of the recipients to efficiently pertain delivery, collection and transportation of collection articles. By efficiently travelling, a wasteful time and consumed energy can be reduced. Further, the position and route of the recipient are indicated through inputs regarding the collection article, so that a burden on the driver for transporting the collection article can be alleviated, and the influence on the delivery business can be reduced.

Although a delivery article of the vehicle 10 is, for example, washed laundry (e.g., clothing and bedding) and a collection article is laundry before washing, a case can be exemplified where facilities for washing (recipients) are different, like ordinary clothing, large-sized items such as bedding, and clothing to be dry-cleaned. Further, a case can be exemplified where a delivery article is a product purchased at a store, a collection article is a waste article, storers (recipients) of waste articles are different among paper waste, cans and bottles, and incombustibles. However, delivery articles and collection articles are not limited to these examples. Note that although the embodiment has illustrated an example in which the vehicle 10 is driven by a driver, information indicating a route for delivery, collection, and transportation of collection articles to recipients that is calculated in the embodiment can be applied to a case where the vehicle 10 is driven automatically.

<Others>

The above embodiment is merely an example, and the present disclosure may be implemented with appropriate changes within the range not deviating from its spirit. Further, a process that is described as performed by one apparatus may be shared and executed by a plurality of apparatuses. Alternatively, processes that are described as performed by different apparatuses may be executed by one apparatus. In a computer system, it can be flexibly changed what hardware configuration is used to implement each function.

The present disclosure can also be implemented by supplying a computer with a computer program in which the functions described in the above embodiment are implemented, and causing one or more processors of the computer to read and execute the program. Such a computer program may be provided to a computer via a non-transitory computer readable storage medium that can be connected to a system bus of the computer, or may be provided to the computer via a network. A non-transitory computer readable storage medium is any type of disk selected from, for example, a magnetic disk (e.g., floppy (R) disk, hard disk drive (HDD)), and an optical disc (e.g., CD-ROM, DVD disc, and Blu-ray disc). Further, non-transitory computer readable media include any type of medium suitable for storing electronic instructions that is selected from, for example, a read-only memory (ROM), a random access memory (RAM), an EPROM, an EEPROM, a magnetic card, a flash memory, and an optical card.

What is claimed is:

1. An information processing method comprising:
setting a travel route of a vehicle that goes through both of a delivery position and a collection position based on information indicating the delivery position of a delivery article and information indicating the collection position of a collection article; and
retrieving at least one recipient corresponding to an attribute of the collection article, and outputting information indicating the retrieved recipient.

2. The information processing method according to claim 1, wherein
the information indicating the recipient includes information indicating a position of the recipient.

3. The information processing method according to claim 2, wherein
the information indicating the recipient further includes information indicating a route to the position of the recipient.

4. The information processing method according to claim 3, further comprising
outputting information for prompting a change of a next via-point in the travel route to the position of the recipient together with the information indicating the recipient.

5. The information processing method according to claim 1, wherein
the information indicating the recipient is output when a relationship between a position of the vehicle and a position of the recipient becomes a predetermined relationship.

6. The information processing method according to claim 5, wherein
the predetermined relationship is that a distance between the position of the vehicle and the position of the recipient becomes shorter than a threshold.

7. The information processing method according to claim 5, wherein
the predetermined relationship is that the position of the vehicle enters a predetermined geographical area including the recipient.

8. The information processing method according to claim 1, wherein
when a plurality of recipients that can receive the collection article is retrieved, one recipient is selected from among the plurality of recipients based on an attribute of a collection article that can be received by the selected recipient.

9. The information processing method according to claim 1, wherein
the travel route is set in one of:
a first mode in which the travel route is set so as to go through the delivery position, then go through the collection position, and thereafter go through a position of the recipient;
a second mode in which the travel route is set so as to go through the delivery position and the collection position in a passing order in which the delivery position and the collection position are mixed, and thereafter go through the position of the recipient; and
a third mode in which the travel route is set in a passing order in which the delivery position, the collection position, and the position of the recipient are mixed.

10. An information processing apparatus comprising
a processor configured to perform:
setting a travel route of a vehicle that goes through both of a delivery position and a collection position based on information indicating the delivery position of the delivery article and information indicating a collection position of a collection article; and
retrieving at least one recipient corresponding to an attribute of the collection article, and outputting information indicating the retrieved recipient.

11. The information processing apparatus according to claim 10, wherein the processor outputs the information indicating the recipient including information indicating a position of the recipient.

12. The information processing apparatus according to claim 11, wherein the processor outputs the information indicating the recipient further including information indicating a route to the position of the recipient.

13. The information processing apparatus according to claim 12, wherein
the processor outputs information for prompting a change of a next via-point in the travel route to the position of the recipient together with the information indicating the recipient.

14. The information processing apparatus according to claim 10, wherein
the processor outputs the information indicating the recipient when a relationship between a position of the vehicle and a position of the recipient becomes a predetermined relationship.

15. The information processing apparatus according to claim 14, wherein
the processor outputs the information indicating the recipient when a distance between the position of the vehicle and the position of the recipient becomes shorter than a threshold.

16. The information processing apparatus according to claim 14, wherein
the processor outputs the information indicating the recipient when the position of the vehicle enters a predetermined geographical area including the recipient.

17. The information processing apparatus according to claim 10, wherein
when a plurality of recipients that can receive the collection article is retrieved, the processor selects one recipient from among the plurality of recipients based on an attribute of a collection article that can be received by the selected recipient.

18. The information processing apparatus according to claim 10, wherein
the processor sets the travel route in one of:
a first mode in which the travel route is set so as to go through the delivery position, then go through the collection position, and thereafter go through a position of the recipient;
a second mode in which the travel route is set so as to go through the delivery position and the collection position in a passing order in which the delivery position and the collection position are mixed, and thereafter go through the position of the recipient; and
a third mode in which the travel route is set in a passing order in which the delivery position, the collection position, and the position of the recipient are mixed.

19. A non-transitory recording medium including a program recorded therein, the program causing a computer to execute:
setting a travel route of a vehicle that goes through both of a delivery position and a collection position based on information indicating the delivery position of a delivery article and information indicating the collection position of a collection article; and
retrieving at least one recipient corresponding to an attribute of the collection article, and outputting information indicating the retrieved recipient.

20. The non-transitory recording medium including the program recorded therein according to claim 19, wherein the program causes the computer to execute outputting the information indicating the recipient including information indicating a position of the recipient.
